(19) United States
(12) Patent Application Publication
(10) Pub. No.: US 2025/0391240 A1
(43) Pub. Date: Dec. 25, 2025

(54) GAMING SYSTEM FOR ALLOWING A USER TO BE AWARDED A REDEEMABLE PRIZE, COMPUTING DEVICE THEREFOR, AND ASSOCIATED METHOD

(71) Applicant: Panayis N. Palexas, Miami, FL (US)

(72) Inventor: Panayis N. Palexas, Miami, FL (US)

(21) Appl. No.: 19/198,413

(22) Filed: May 5, 2025

Related U.S. Application Data
(60) Provisional application No. 63/663,348, filed on Jun. 24, 2024.

(51) Int. Cl. G07F 17/32

(52) U.S. Cl. CPC G07F 17/3244

(57) ABSTRACT

A gaming system includes a device server and at least one computing device. The computing device includes a display device, a memory, and a processor configured to execute instructions of the memory in order to display a game to the user on the display device, confirm that the user has employed a consideration-free tool in play of the game in order to adjust a virtual balance, initiate the game and adjust the virtual balance of the user from a first balance to a second balance responsive to an outcome of the game, responsive to the user opting in to a skill-based promotion, display and initiate the skill-based promotion on the display device while employing the second balance as an entry method for the user in the skill-based promotion, and award a redeemable prize to the user if the skill-based promotion results in a winning outcome.

### CROSS REFERENCE TO RELATED APPLICATION

This application claims priority to and claims the benefit of U.S. Provisional Patent Application Ser. No. 63/663,348, filed Jun. 24, 2024, and entitled “SYSTEMS, METHODS, AND NON-TRANSITORY COMPUTER-READABLE STORAGE MEDIA FOR DISPLAYING ANIMATED SEQUENCES OF COMPUTER-GENERATED IMAGES OF SKILL-BASED GAMES”, the contents of which are incorporated herein by reference in their entirety.

### BACKGROUND

Gaming systems and their associated computing devices allow users to play games, such as casino-type games. At least some gaming systems allow social casino websites to be displayed in order to offer casino-type gaming to users. The casino-type games may include, for example, video slot games and/or video card games. Additionally, games may be offered to players wherein the players often wager virtual currency that has been freely awarded. When the players then go on to win virtual currency (e.g., credits or virtual coins) in one of these games, they often continue to use this virtual currency during gaming. Legally, this may be interpreted as risking the winnings, and therefore could be construed as illegal gambling in some jurisdictions.

It is with respect to these and other considerations that the instant disclosure is concerned.

### SUMMARY

In one aspect of the disclosed concept, a gaming system for allowing a user to be awarded a redeemable prize is provided. The gaming system comprises a device server; and at least one computing device in communication with the device server via a communications network, the at least one computing device comprising a display device for rendering computer-generated graphics, a memory, and a processor configured to execute instructions of the memory in order to display a game to the user on the display device, confirm that the user has employed a consideration-free tool in play of the game in order to adjust a virtual balance, initiate the game and adjust the virtual balance of the user from a first balance to a second balance responsive to an outcome of the game, responsive to the user opting in to a skill-based promotion, display and initiate the skill-based promotion on the display device while employing the second balance as an entry method for the user in the skill-based promotion, and award the redeemable prize to the user if the skill-based promotion results in a winning outcome.

In yet another aspect, a computing device for use in the aforementioned gaming system is provided.

In yet another aspect, a method comprises displaying a game to a user on a display device of a computing device; confirming that the user has employed a consideration-free tool in play of the game in order to adjust a virtual balance; initiating the game and adjusting the virtual balance of the user from a first balance to a second balance responsive to an outcome of the game; responsive to the user opting in to a skill-based promotion, displaying and initiating the skill-based promotion on the display device while employing the second balance as an entry method for the user in the skill-based promotion; and awarding the redeemable prize to the user if the skill-based promotion results in a winning outcome.

### BRIEF DESCRIPTION OF THE DRAWINGS

Non-limiting and non-exhaustive embodiments of the present invention are described with reference to the following figures. Other advantages of the present disclosure will be readily appreciated, as the same becomes better understood by reference to the following detailed description when considered in connection with the accompanying drawings wherein:

FIG. 1 is a schematic illustrating a gaming system and associated computing devices, in accordance with one non-limiting embodiment of the disclosed concept;

FIG. 2 is a flowchart corresponding to an example method of allowing a user to be awarded a redeemable prize with one of the computing devices of FIG. 1;

FIG. 3 is another flowchart corresponding to the example method of FIG. 2; and

FIGS. 4 and 5 are illustrations of first and second exemplary graphical user interface screens that may be displayed on one of the computing devices of FIG. 1, according to non-limiting embodiments of the disclosed concept.

### DETAILED DESCRIPTION

As employed herein, the term “consideration-free tool” shall mean a virtual currency that is freely given to a user without a direct exchange of consideration for the virtual currency, such as, for example and without limitation, given to a user when other virtual currency is purchased by the user, and/or when at least one of a registration bonus, daily bonus, SMS bonus, trivia contest bonus, request by post, and/or Facebook bonus is awarded to a user without direct consideration. Consideration-free tools preferably have no value during gaming, but may be used as wagers during play of games.

With reference to the figures and in operation, the present invention provides a gaming system 10, in accordance with one non-limiting embodiment of the disclosed concept. In one example, the gaming system 10 is configured to render animated sequences of computer-generated images of games (e.g., casino-type games or other games) on user computing devices, which may include skill-based promotions (e.g., games) for awarding prizes.

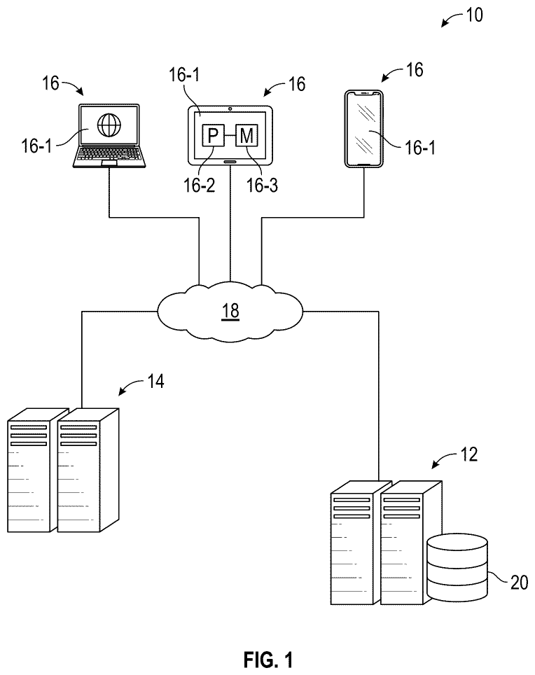

In the illustrated embodiment of FIG. 1, the gaming system 10 includes a device server (e.g., gaming computer server 12) coupled to and in communication with a website hosting server 14 via a communications network 18, and a plurality of user computing devices 16 in communication with the gaming computer server 12 via the communications network 18. The communications network 18 may be any suitable connection, including the Internet, file transfer protocol (FTP), an Intranet, LAN, a virtual private network (VPN), cellular networks, etc., and may utilize any suitable or combination of technologies including, but not limited to wired and wireless connections, always on connections, connections made periodically, and connections made as needed.

Each computer system and/or server may include one or more server computers that each include a processing device that includes a processor that is coupled to a memory device. The processing device executes various programs, and thereby controls components of the server according to user instructions received from the user computing devices 16 and/or other servers. The processing device may include memory, e.g., read only memory (ROM) and random access memory (RAM), storing processor-executable instructions and one or more processors that execute the processor-executable instructions.

Each user computing device 16 preferably includes a display device 16-1 for rendering computer-generated graphics. In one example, the computing devices 16 each further include a processor and a memory (e.g., processor 16-2 and memory 16-3 are shown on one of the computing devices 16 in simplified form, although it will be appreciated that each of the other computing devices 16 preferably also include a similarly configured processor and a memory). The processor 16-2 executes various instructions of the memory 16-3, and thereby controls components of the computing device 16 according to user instructions received by the user to enable the user to access and communicate with the gaming system 10. This may include sending and/or receiving information to and from the gaming system 10 and displaying information received from the gaming system 10 to the user.

It will be appreciated that the user computing devices 16 may be, but are not limited to, a desktop computer, a laptop or notebook computer, a tablet computer, smartphone/tablet computer hybrid, a personal data assistant, a handheld mobile device including a cellular telephone, and the like. In addition, the user computing device 16 may include a touchscreen that operates as the display device 16-1 and the user input device.

In the illustrated embodiment, the user computing device 16 includes a web-browser program that is stored in the memory 16-3. When executed by the processor 16-2 of the user computing device 16, the web-browser program enables the user computing device 16 to receive software code from the website hosting server 14 including, but not limited to HTML, JavaScript, and/or any suitable programming code that enables the user computing device 16 to generate and display a website and/or webpages on the display device 16-1 of the user computing device 16. The web-browser program also enables the user computing device 16 to receive instructions from the website hosting server 14 that enable the user computing device 16 to render HTML code for use in generating and displaying portions of the website and/or webpage.

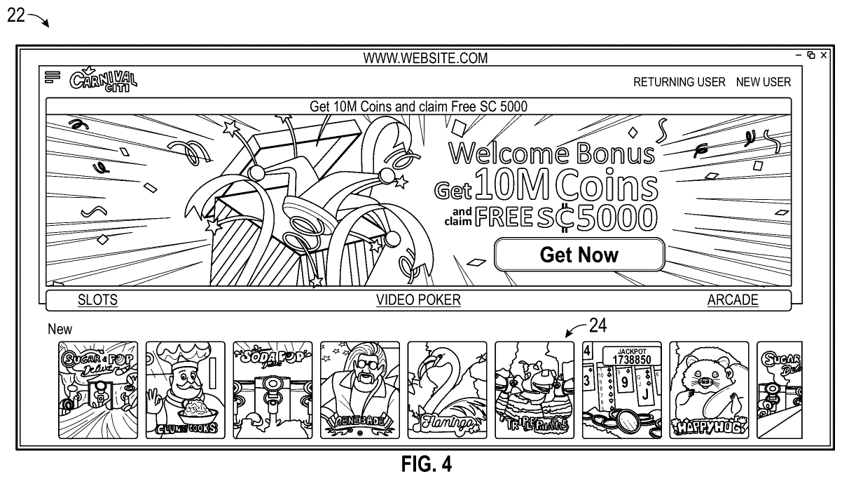

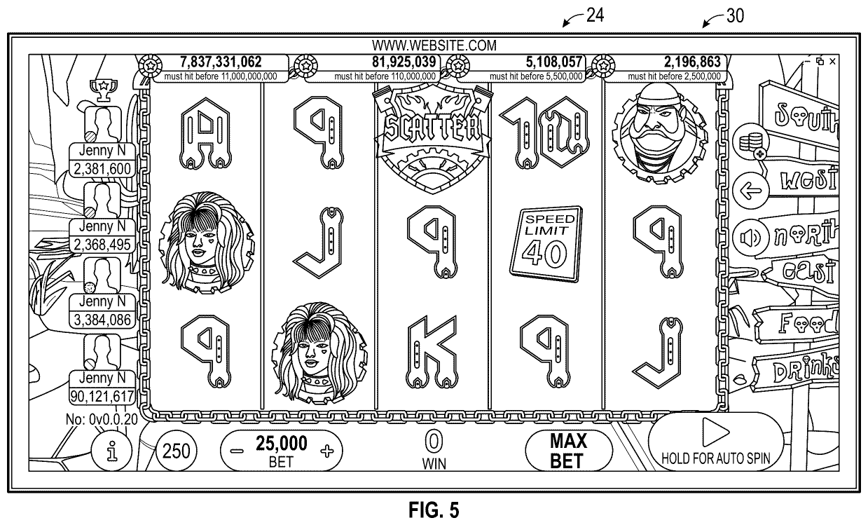

The website hosting server 14 may be programmed to host a website including webpages (shown in FIGS. 4-5) that is accessible by a user via one or more user computing devices 16. The website hosting server 14 executes a website application program that retrieves application code being stored in a database and executes the application code including the software components to render one or more webpages on the display device 16-1 of the user computing device 16 in response to requests received from the user via the user computing device 16 to allow users to interact with the website.

The gaming computer server 12 includes one or more gaming processors 20 configured to perform operations to support the functions of the webpages and/or website being displayed by the website hosting server 14.

In the illustrated embodiment, the gaming computer server 12 may be programmed to render a social casino website 22 (e.g., shown in FIG. 4) on the user computing devices 16 using the website hosting server 14, and include programs for executing and displaying a plurality of games (e.g., without limitation, casino-type games) on the social casino website 22 (FIG. 4). The gaming computer server 12 includes one or more gaming processors 20 programmed to render animated sequences of computer-generated images of skill-based promotions (e.g., games) on the user computing devices 16 which include social casino games with skill-based promotions for awarding prizes.

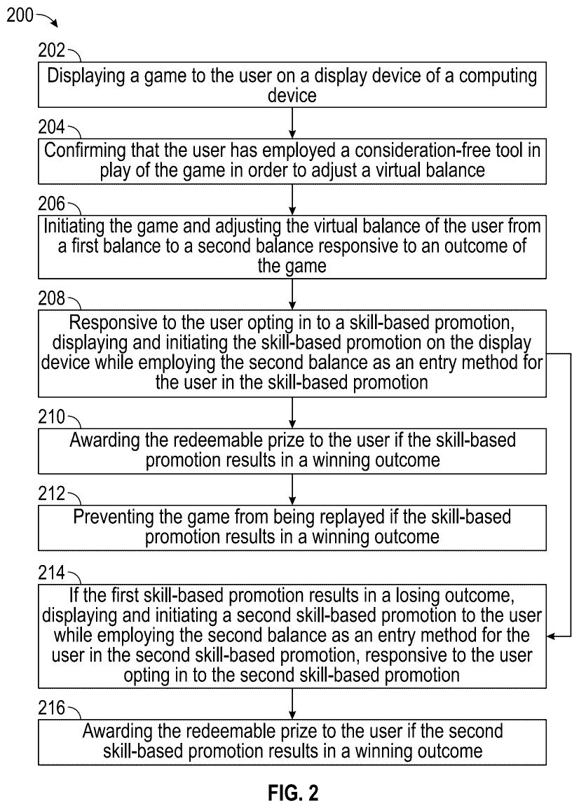

In accordance with the disclosed concept, FIG. 2 illustrates a flowchart corresponding to an example method 200 of allowing a user to play a game, which may be a casino-type game, on one of the user computing devices 16. In one example, the processor 16-2 (FIG. 1) is configured to execute instructions of the memory 16-3 (FIG. 1) in order to allow the user to communicate with the website hosting server 14, and to perform a first step 202 of displaying a game to the user on a display device 16-1 of a computing device 16, a second step 204 of confirming that the user has employed a consideration-free tool in play of the game in order to adjust (e.g., increase responsive to a win or decrease responsive to a loss) a virtual balance, a third step 206 of initiating the game and adjusting the virtual balance of the user from a first balance to a second balance responsive to an outcome of the game, a fourth step 208 of, responsive to the user opting in (e.g., selecting on the display device 16-1 responsive to either a winning outcome or a losing outcome of the game) to a skill-based promotion, displaying and initiating the skill-based promotion on the display device 16-1 while employing the second balance as an entry method (e.g., without limitation, a tool for play) for the user in the skill-based promotion, and a fifth step 210 of awarding the redeemable prize to the user if the skill-based promotion results in a winning outcome.

In one example, the game contemplated by the method 200 of FIG. 2 is a casino-type game configured to be displayed on a social casino website, although it will be appreciated that other type games in other forums are contemplated herein. More specifically, it is also contemplated that the game may be a slot game, arcades, poker, keno, backgammon, or any game that requires the play of virtual currency. Further, it is contemplated that the skill-based promotion may be a trivia question, a tic-tac-toe game, a matching game, or any game that requires skill (e.g., a step that requires the player to provide selective input in order to pass). Moreover, a “skill-based promotion” may refer to a system, such as a game, where a player may advance to a higher position in the system based on their demonstrated skill and performance rather than simply, for example and without limitation, time played or random chance.

Unlike known games, wherein users are forced to risk their winnings during continued play, the disclosed concept, as can be appreciated with the method 200 of FIG. 2, advantageously allows the user to be awarded a redeemable prize (e.g., prize money) from a skill-based promotion without a risk of loss of virtual currency won during play of a game (e.g., a casino-type game). Specifically, the separate skill-based promotion provided to the user before awarding of a redeemable prize provides this capability. In this manner, the skill-based promotion is configured to be displayed and initiated in a manner wherein a virtual balance (e.g., the balance after an outcome of a play of an initial game entered via a consideration-free tool) is employed as an entry method (e.g., without limitation, a tool for play) in the skill-based promotion. It will be appreciate then that the example method 200 preferably includes a sixth step 212 of preventing the game from being replayed if the skill-based promotion results in a winning outcome.

Accordingly, there is no risk of loss of the virtual balance (e.g., a second balance that has been adjusted from a first balance responsive to an outcome of the initial game). In one example, if the skill-based promotion from step 208 results in a losing outcome, the method 200 preferably further includes (e.g., via the processor 16-2 executing instructions of the memory 16-3) a seventh step 214 of displaying and initiating a second skill-based promotion to the user while employing the second balance as an entry method for the user in the second skill-based promotion, responsive to the user opting in to the second skill-based promotion, and an eighth step 216 of awarding the redeemable prize to the user if the second skill-based promotion results in a winning outcome. In one example, the first skill-based promotion (e.g., the one that may have been lost by the user) and the second skill-based promotion are different games, but in other examples the two games are the same. In yet a further example, the first and second skill-based promotions are each randomly generated from among a plurality of skill-based promotions.

And in accordance with the disclosed concept, if the second skill-based promotion results in a losing outcome, the method 200 is configured to continually display and initiate a skill-based promotion (e.g., a third skill-based promotion, a fourth skill-based promotion, a fifth skill-based promotion, etc.) without requiring a wager for the subsequent skill-based promotions until the skill-based promotion is won, at which point the method 200 calls for awarding a redeemable prize (e.g., prize money) to the user if/when the third, fourth, fifth, etc., skill-based promotion results in a winning outcome. In this manner, the user never risks his or her virtual balance in the skill-based promotions, advantageously allowing the user to legally redeem a redeemable prize (e.g., prize money) from play of the game.

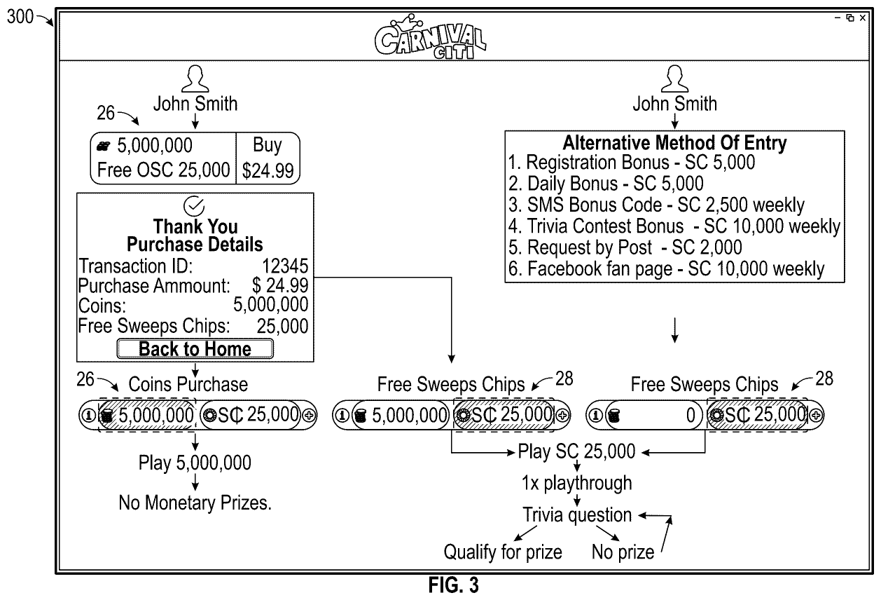

FIG. 3 is another flowchart illustrating an algorithm 300 executed by the gaming computer server 12 for use in rendering animated sequences of computer-generated images of social casino-type games with skill-based elements for awarding prizes. FIGS. 4 and 5 are illustrations of exemplary graphical user interface screens and/or windows rendered by the website hosting server 14 based on computer-instructions provided by the gaming computer server 12 and displayed on the display devices of the user computing devices 16.

Referring again to FIG. 2, in method step 202, the gaming processor 20 may render the social casino website 22 on one or more user computing devices 16 including a plurality of casino-type games 24 that are selectable by the player via the corresponding user computing device 16. In some embodiments, the gaming processor 20 may prompt an existing player to log-in to an existing player account using player ID credentials, and access the existing player account upon verifying the player ID credentials.

Referring to FIG. 3, the existing player account may include information associated with the player and an amount of Coins 26 that may be used to play the casino-type games 24 (FIGS. 4 and 5). In addition, the player account may include an amount of Sweeps chips 28 that may also be used as consideration-free tools to play the casino-type games 24.

Furthermore, the gaming processor 20 may prompt a new player to create a player account by inputting corresponding player information, including verifiable player ID credentials. The gaming processor 20 may then create a corresponding player account upon receiving corresponding player information and verifiable player ID credentials, and assign the corresponding player account and amount of Coins 26 and/or Sweeps chips 28 for use in playing the casino-type games 24. The gaming processor 20 may also be programmed to enable the player to purchase an amount of Coins 26, and award an amount of Sweeps chips 28 upon verifying the purchase of Coins 26.

Upon receiving a player's selection of a game 24 (e.g., a casino-type game), the gaming processor 20 then renders a game screen 30 (FIG. 5) on the user computing device 16 (e.g., on the display device 16-1, shown in FIG. 1) including images of the game 24. For example, as shown in FIG. 5, the player selected a casino-type game 24, which may include a video slot game including a plurality of reels displaying a plurality of symbols within a grid.

In method step 204, the gaming processor 20 receives a signal from the user computing device 16 indicating a request from the player to play an instance of the game 24 and determines whether Sweeps chips 28 or Coins 26 have been used to play the initial game 24 (e.g., in order to confirm that a consideration-free tool has been employed). If the play request includes an amount of Sweeps chips 28 (e.g., if, at step 204 it is confirmed that a consideration-free tool), the gaming processor 20 proceeds to method steps 206-216. In this way, a redeemable prize (e.g., prize money) may be awarded to the player only if the player has used Sweeps chips 28 to play the game 24 and subsequently won a skill-based promotion.

In method step 208, responsive to the user opting in to the skill-based promotion, the gaming processor 20 then displays and initiates the skill-based promotion on the display device 16-1 (FIG. 1). For example, in some embodiments, the gaming processor 20 may render images of a trivia question game on the display device 16-1 prompting the player to submit answers to the trivia question game. Subsequently, if a winning result is obtained by the player to the skill-based promotion, the gaming processor 20 executes methods step 210 to award a redeemable prize, such as a prize money (e.g., a monetary award), to the player. If the player does not obtain a winning result, the gaming processor 20 proceeds to method step 214, whereby the player is given another chance with another skill-based promotion, and without having to make a separate additional wager. This last step may be repeated over and over with additional skill-based promotions, which may be the same or different than previous skill-based promotions, until a winning outcome occurs. The skill-based step thus provides an added layer to the player to allow for a prize to be redeemed, and in a manner wherein a virtual balance provided after play of one or more games 24 is not risked.

In some embodiments, Sweeps Chips 28 may be used to play games which give a chance to compete in various competitions to win prizes. The amount of Sweeps Chips 28 required to play each game varies and is prominently displayed on the display devices 16-1 (FIG. 1). The score card, reward table, and rules of each game in accordance with the disclosed concept can be seen by clicking an “info” button of the game. In some instances, increasing the amount of the Sweeps Chips 28 played may increase winning eligibility.

In accordance with the disclosed concept, in order to win prizes, the player must play-through Sweeps Chips 28 a minimum one time and win a skill-based promotion, such as correctly answering a trivia question. When this done, the player can redeem winnings, such as withdraw winnings in United States dollars (e.g., to the account which was used to buy Coins 26 or to an alternative bank).

Any combination of one or more computer-usable or computer-readable media (or medium) may be utilized. For example, a computer-readable media may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable media that can direct a computer or other programmable data processing apparatus to function in a particular manner, such that the instructions stored in the computer-readable media produce an article of manufacture including instruction means which implement the function/act specified in the flowchart and/or block diagram block or blocks.

Several (or different) elements discussed below, and/or claimed, are described as being “coupled”, “in communication with”, or “configured to be in communication with”. This terminology is intended to be non-limiting, and where appropriate, be interpreted to include without limitation, wired and wireless communication using any one or a plurality of a suitable protocols, as well as communication methods that are constantly maintained, are made on a periodic basis, and/or made or initiated on an as needed basis. The term “coupled” means any suitable communications link, including but not limited to the Internet, a LAN, a cellular network, or any suitable communications link. The communications link may include one or more of a wired and wireless connection and may be always connected, connected on a periodic basis, and/or connected on an as needed basis.

A controller, computing device, server or computer, such as described herein, includes at least one or more processors or processing units and a system memory (see above). The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a database, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, MongoDB™ database engines which is a document storage solution, Oracle® Database, MySQL, IBM® Db2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.

While the present disclosure has been described with reference to various implementations, it will be understood that these implementations are illustrative and that the scope of the disclosure is not limited to them. Many variations, modifications, additions, and improvements are possible. More generally, implementations in accordance with the present disclosure have been described in the context of particular implementations. Functionality can be separated or combined in blocks differently in various implementations of the disclosure or described with different terminology. These and other variations, modifications, additions, and improvements can fall within the scope of the disclosure as defined in the claims that follow.

What is claimed is:

1. A gaming system for allowing a user to be awarded a redeemable prize, comprising:
a device server; and
at least one computing device in communication with the device server via a communications network, the at least one computing device comprising:
a display device for rendering computer-generated graphics,
a memory, and
a processor configured to execute instructions of the memory in order to:
display a game to the user on the display device,
confirm that the user has employed a consideration-free tool in play of the game in order to adjust a virtual balance,
initiate the game and adjust the virtual balance of the user from a first balance to a second balance responsive to an outcome of the game,
responsive to the user opting in to a skill-based promotion, display and initiate the skill-based promotion on the display device while employing the second balance as an entry method for the user in the skill-based promotion, and
award the redeemable prize to the user if the skill-based promotion results in a winning outcome.

2. The gaming system according to claim 1, wherein the skill-based promotion is a first skill-based promotion, wherein, if the first skill-based promotion results in a losing outcome, the processor is configured to display and initiate a second skill-based promotion to the user while employing the second balance as an entry method for the user in the second skill-based promotion, responsive to the user opting in to the second skill-based promotion, and award the redeemable prize to the user if the second skill-based promotion results in a winning outcome.

3. The gaming system according to claim 2, wherein, if the first skill-based promotion or the second skill-based promotion results in a winning outcome, the processor is configured to execute the instructions of the memory in order to prevent the game from being replayed.

4. The gaming system according to claim 2, wherein the processor is configured to display and initiate the second skill-based promotion without requiring a wager for the second skill-based promotion.

5. The gaming system according to claim 2, wherein the redeemable prize comprises prize money.

6. The gaming system according to claim 2, further comprising a host server in communication with the device server, wherein the processor is further configured to execute the instructions of the memory in order to allow the user to communicate with the host server, wherein the game is a casino-type game, and wherein the processor is further configured to execute the instructions of the memory in order to display the casino-type game on a social casino website.

7. A computing device for a gaming system, comprising:
a display device for rendering computer-generated graphics;
a memory; and
a processor configured to execute instructions of the memory in order to:
display a game to the user on the display device,
confirm that the user has employed a consideration-free tool in play of the game in order to adjust a virtual balance,
initiate the game and adjust the virtual balance of the user from a first balance to a second balance responsive to an outcome of the game,
responsive to the user opting in to a skill-based promotion, display and initiate the skill-based promotion on the display device while employing the second balance as an entry method for the user in the skill-based promotion, and
award the redeemable prize to the user if the skill-based promotion results in a winning outcome.

8. The computing device according to claim 7, wherein, if the skill-based promotion results in a winning outcome, the processor is configured to execute the instructions of the memory in order to prevent the game from being replayed.

9. The computing device according to claim 8, wherein the redeemable prize comprises prize money.

10. The computing device according to claim 8, wherein the skill-based promotion is a first skill-based promotion, wherein, if the first skill-based promotion results in a losing outcome, the processor is configured to display and initiate a second skill-based promotion to the user while employing the second balance as an entry method for the user in the second skill-based promotion, responsive to the user opting in to the second skill-based promotion, and award the redeemable prize to the user if the second skill-based promotion results in a winning outcome.

11. The computing device according to claim 10, wherein the first and second skill-based promotions are different.

12. The computing device according to claim 10, wherein the first and second skill-based promotions are each randomly generated from among a plurality of skill-based promotions.

13. The computing device according to claim 10, wherein, if the second skill-based promotion results in a losing outcome, the processor is configured to display and initiate a third skill-based promotion to the user while employing the second balance as an entry method for the user in the third skill-based promotion, responsive to the user opting in to the third skill-based promotion, and award the redeemable prize to the user if the third skill-based promotion results in a winning outcome.

14. A method of allowing a user to be awarded a redeemable prize, comprising:
displaying a game to the user on a display device of a computing device;
confirming that the user has employed a consideration-free tool in play of the game in order to adjust a virtual balance;
initiating the game and adjusting the virtual balance of the user from a first balance to a second balance responsive to an outcome of the game;
responsive to the user opting in to a skill-based promotion, displaying and initiating the skill-based promotion on the display device while employing the second balance as an entry method for the user in the skill-based promotion; and
awarding the redeemable prize to the user if the skill-based promotion results in a winning outcome.

15. The method according to claim 14, further comprising preventing the game from being replayed if the skill-based promotion results in a winning outcome.

16. The method according to claim 14, wherein the redeemable prize comprises prize money.

17. The method according to claim 14, wherein the skill-based promotion is a first skill-based promotion, and wherein, if the first skill-based promotion results in a losing outcome, the method further comprises displaying and initiating a second skill-based promotion to the user while employing the second balance as an entry method for the user in the second skill-based promotion, responsive to the user opting in to the second skill-based promotion, and awarding the redeemable prize to the user if the second skill-based promotion results in a winning outcome.

18. The method according to claim 17, wherein, if the second skill-based promotion results in a losing outcome, the method further comprises displaying and initiating a third skill-based promotion to the user while employing the second balance as an entry method for the user in the third skill-based promotion, responsive to the user opting in to the third skill-based promotion, and awarding the redeemable prize to the user if the third skill-based promotion results in a winning outcome.

19. The method according to claim 17, wherein, if the first skill-based promotion or the second skill-based promotion results in a winning outcome, the method further comprises preventing the game from being replayed.

20. The method according to claim 19, wherein the redeemable prize comprises prize money, and wherein the first and second skill-based promotions are each randomly generated from among a plurality of skill-based promotions.
